(19) United States
(12) Patent Application Publication
(10) Pub. No.: US 2026/0366402 A1
(43) Pub. Date: Nov. 19, 2026

(54) METHODS OF IMPROVING CO2 TRAPPING AND MINERALIZATION VIA WATER-ALTERNATING-GAS CYCLING INJECTIONS IN SUBSURFACE ROCK RESERVOIRS

(71) Applicant: The Trustees of Columbia University in the City of New York, New York, NY (US)

(72) Inventors: DAVID S. GOLDBERG, New York, NY (US); CLAIRE J. NELSON, New York, NY (US)

(73) Assignee: The Trustees of Columbia University in the City of New York, New York, NY (US)

(21) Appl. No.: 19/136,543

(22) PCT Filed: Dec. 11, 2023
(86) PCT No.: PCT/US2023/083286

§ 371 Date: Jun. 6, 2025

Related U.S. Application Data
(60) Provisional application No. 63/431,521, filed on Dec. 9, 2022.
(60) Provisional application No. 63/608,339, filed on Dec. 11, 2023.

(51) Int. Cl. E21B 41/00; B65G 5/00

(52) U.S. Cl. CPC E21B 41/0064; B65G 5/00; E21B 2200/20

(57) ABSTRACT

Methods of trapping and mineralizing CO2 in a rock reservoir, such as one with a high concentration of mafic minerals, are provided. The method includes injecting a first quantity of free-phase, supercritical CO2 into the rock reservoir at a first rate and for a first duration; injecting a second quantity of water into the rock reservoir at a second rate and for a second duration; and repeating at least one of the above injection steps in an alternating fashion for a plurality of injection cycles. The first and second quantities, the first and second rates, the first and second durations, and a total number of the plurality of injection cycles are selected to improve trapping and mineralization efficiency in the rock reservoir and reduce the amounts of energy and water consumed. These systems and methods demonstrate efficacy in geographically diverse locations, broadening the available geographic storage for carbon dioxide sequestration.

### CROSS-REFERENCE TO RELATED APPLICATIONS

This application claims the priority benefit of U.S. Provisional Patent Application No. 63/431,521, filed Dec. 9, 2022, and U.S. Provisional Patent Application No. 63/608,339, filed Dec. 11, 2023, the entirety of each of the disclosures of which are explicitly incorporated by reference herein.

### STATEMENT REGARDING FEDERALLY SPONSORED RESEARCH OR DEVELOPMENT

This invention was made with government support under Grant Number DE-FE0029219 awarded by the Department of Energy. The government has certain rights in the invention.

### BACKGROUND

To meet global climate goals set by the Paris Climate Agreement, it is estimated that hundreds of gigatons of geologic carbon storage is needed, both to decarbonize our global economy with point-source capture and storage, as well as to generate the gigatons of carbon dioxide removals (e.g., via direct air capture and storage) required per year by 2050 and beyond. Traditional geologic carbon storage, a mature technology deployed initially for enhanced oil recovery (“EOR”), involves injecting CO₂ into sedimentary rock formations, where the carbon is sealed underground by geologic structures and the majority of the injected CO₂ persists in the free-phase for thousands of years. Alternatively, carbon may be stored in mafic rocks, and specifically by in-situ mineralization, where carbon is sequestered in aqueous phase via dissolution, and subsequently in mineral form through silicate chemical weathering and carbonate precipitation reactions. Unlike traditional geologic storage in sedimentary basins, in-situ mineralization offers the advantageous likelihood that the primary trapping mechanism is geochemical, rather than structural, as the injected carbon is ultimately sequestered in a stable solid form. Mineralization of carbon injected into mafic rocks, such as basalt, is a promising technology for permanent geologic storage that has the potential to decrease project liability, shorten the timescale of monitoring required to ensure no leakage, increase project public acceptance, and broaden the geographic range where geologic carbon storage is feasible.

In-situ mineralization in basalt has been demonstrated at the field-scale during two pilot experiments: The CarbFix projects in Iceland and the Wallula Project in Washington, USA. During the CarbFix1 experiment, CO₂ was dissolved into water prior to injection at approximately a 25:1 water to gas ratio, resulting in near complete mineralization within two years. The Wallula Pilot injected free-phase (supercritical) CO₂, relying in part on structural mechanisms (low permeability lava flows) to trap CO₂ in the subsurface while geochemical reactions proceeded, resulting in ~60% mineralization over that same timeframe. Despite the success of these two pilots, key questions remain regarding the efficacy and timeframe of mineralization during scaled injections and the availability and use of large amounts of water.

While Wallula-style injections (100% CO₂ and no water) circumvent some issues for water use and maximize per-well injection capacity, free-phase only injections also have constraints at scale. Silicate mineral dissolution and carbonate precipitation reactions in basaltic reservoirs are geochemically inhibited during large free-phase CO₂ injections, and injected CO₂ may take tens of thousands of years to mineralize at these scales. While direct reactivity between free-phase CO₂ and silicate minerals has been documented, the efficiency at which injected free-phase CO₂ can mineralize depends in part on the availability of formation water to dissolve the CO₂, thus mineralization is limited in part by formation water volume. Although using seawater may mitigate the issue of water demand for a water-dissolved approach, more work focused on free-phase injections for in-situ mineralization is needed to determine the viability for the large-scale (megaton or gigaton) projects needed to achieve climate relevance.

What is needed, therefore, are improved methods of in-situ CO₂ mineralization that address at least the problems described above.

### SUMMARY

Accordingly, some embodiments of the disclosed subject matter are directed to methods and injection strategies to improve in-situ mineralization at scale via water-alternating-gas (“WAG”) cycled injections of free-phase CO₂ and water. In some embodiments, the method involves the injection of free-phase CO₂ into a porous mafic rock formation, where it dissolves into the preexisting groundwater saturating the rock, then “flushing” the reservoir with water to quickly replenish subsurface fluids. Embodiments of WAG injections disclosed herein for mineralization circumvent the limitations of the traditional approaches discussed above. Incorporating free-phase CO₂ into injections of carbon into mafic reservoirs reduces water demand and increases per-well injection capacity, and cycling water promotes the geochemical reactions that result in solubility and mineral trapping, shortening time-to-mineralization during scaled injections relative to free-phase only scenarios.

According to an embodiment of the disclosed subject matter, a method of trapping and mineralizing CO₂ in a rock reservoir is provided. The method includes injecting a first quantity of free-phase CO₂ into the rock reservoir at a first rate and for a first duration; injecting a second quantity of water into the rock reservoir at a second rate and for a second duration; and repeating the at least one of the above injection steps in an alternating fashion for a plurality of injection cycles.

In some embodiments, the CO₂ is trapped in aqueous phase and/or mineralized in the rock reservoir.

In some embodiments, the rock reservoir is basaltic, silicate, mafic, ultramafic, sedimentary, or combinations thereof.

In some embodiments, the free-phase CO₂ is in supercritical form.

In some embodiments, the water is freshwater. In some embodiments, the water is seawater or brine. In some embodiments, the water is saturated with dissolved CO₂. In some embodiments, the water is sourced from the rock reservoir.

In some embodiments, the total number of the plurality of injection cycles is in the range of about 2 to about 400.

In some embodiments, the first duration is in the range of about 1 day to about 416 days, and the second duration is in the range of about 1 day to about 1,900 days.

In some embodiments, the first rate is in the range of about 0.001% to about 80% of a first total quantity of free-phase CO₂ injected over the plurality of injection cycles in tons per day, and the second rate is in the range of about 0.01% to about 80% of a second total quantity of water injected over the plurality of injection cycles in tons per day. In some embodiments, the first rate is in the range of about 10 tons per day to about 20,548 tons per day. In some embodiments, the first rate is in the range of about 1,015 tons per day to about 20,548 tons per day, and the second rate is in the range of about 4,284 tons per day to about 25,000 tons per day.

In some embodiments, a ratio of the second quantity to the first quantity is in the range of about 0.5 to about 242. In some embodiments, the ratio of the second quantity to the first quantity is less than 30.

In some embodiments, a ratio of the second rate to the first rate is in the range of about 0.60 to about 16.7.

In some embodiments, a ratio of the second duration to the first duration is in the range of about 0.3 to about 15.2.

According to another embodiment of the disclosed subject matter, a method of designing a strategy for injecting CO₂ and water in an alternating fashion for trapping and mineralizing the CO₂ in a rock reservoir is provided. The method includes developing a model of the rock reservoir based on geologic and geophysical data at or near the rock reservoir; selecting a quantity of CO₂ to be injected; selecting a quantity of water to be injected; selecting characteristics associated with an injection site of the rock reservoir; modeling the impact on trapping and mineralization efficiency at the rock reservoir of a plurality of injection parameters at least partly based on the selected injection site characteristics; and defining the injection strategy by defining the plurality of injection parameters to improve trapping and mineralization efficiency, reduce energy consumption, and reduce water consumption. The plurality of injection parameters includes a plurality of injection cycles, a ratio of the quantity of injected water to the quantity of injected CO₂, a ratio of the rate of water injection to the rate of CO₂ injection, and a ratio of the water injection cycle duration to the CO₂ injection cycle duration. Each injection cycle includes a first injection of CO₂ and a second injection of water.

In some embodiments, the injection site characteristics include injection depth, injection site porosity, injection site permeability, temperature, pressure, rock reservoir composition, rock reservoir geological age, and water depth.

According to another embodiment of the disclosed subject matter, a method of trapping and mineralizing CO₂ in a rock reservoir is provided. The method includes injecting a first quantity of supercritical CO₂ into the rock reservoir at a first rate and for a first duration; injecting a second quantity of water into the rock reservoir at a second rate and for a second duration; and repeating at least one of the above injection steps in an alternating fashion for a plurality of injection cycles. The water includes freshwater, seawater, brine, water sourced from the rock reservoir, or combinations thereof. The total number of the plurality of injection cycles is in the range of about 1 to about 400. A ratio of the second quantity to the first quantity is in the range of about 0.1 to about 35. A ratio of the second rate to the first rate is in the range of about 0.1 to about 17. A ratio of the second duration to the first duration is in the range of about 0.1 to about 16.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a flowchart of a method of mineralizing CO₂ in a rock reservoir according to some embodiments of the disclosed subject matter.

FIG. 2 is a flowchart of a method of designing a strategy for injecting CO₂ and water in an alternating fashion for mineralizing the CO₂ in a rock reservoir according to some embodiments of the disclosed subject matter.

FIG. 3 is a chart showing the mass of mineralized CO₂ versus time for select simulations of a 1 Mt injection of CO₂ into a first example site, Cascadia basin.

FIG. 4 is a chart showing the mass of mineralized CO₂ over time for three injection strategies simulating the 1 Mt injection of CO₂ into the first example site, Cascadia (solid lines), and a second example site, Louisville (dashed lines).

FIG. 5 is a chart showing the Improvement Factor for the subset of WAG scenarios simulated at three example sites versus W_{WAG}.

FIG. 6 is a table showing a summary of injection parameters and results of a 1 Mt injection simulated at the Cascadia site and monitored for 40 years.

FIG. 7 is a table showing results of the high-level sensitivity analysis for simulations performed using data from the Cascadia site.

FIG. 8 is a table showing results of scenarios investigated at the three example sites.

### DETAILED DESCRIPTION

Mineral carbon storage is an effective means of durable and verifiable geologic carbon storage. Accordingly, some embodiments of the disclosed subject matter are directed to methods of improving subsurface mineralization via water-alternating-gas (“WAG”) cycled injections of free-phase CO₂ (e.g., supercritical) and water. Incorporating injections of supercritical CO₂ (“scCO₂”) into basalt minimizes water demand, increases per-well injection capacity, and expands the feasible range of basalt carbon storage. Cycling water between injections of scCO₂ accelerates geochemical reactions that induce solubility and mineral trapping. In some embodiments, injection strategies and models of water-dissolved, scCO₂-only, and WAG injections into subsea and onshore basalt rock reservoirs were simulated. Some embodiments simulated WAG injections into mid-ocean ridge basalt at the Juan de Fuca plate in the Northeast Pacific Ocean to investigate injection parameters and reservoir characteristics that accelerate mineralization during WAG injections. In some embodiments, WAG injections improve mineralization to about 100% of a 1 million metric tons (“Mt”) CO₂ injection within 40 years. Such improved WAG injections approximately double mineralization compared to traditional scCO₂-only injections, while using half as much water as a water-dissolved approach.

In some embodiments, WAG injections improve solubility trapping. Some embodiments compared the efficiency of WAG injections by simulating scenarios at two additional sites: offshore basalt in the Louisville Seamount, a suboceanic volcano in the Southwest Pacific, and continental flood basalt along the Columbia River in Washington State. In some embodiments, faster mineralization occurred at the Louisville seamount than Juan de Fuca site, likely due to variations with different injection-zone mineralogies. In some embodiments, WAG scenarios at the Columbia River site improved mineralization the most relative to scCO₂-only injections and increased feasible per-well injection rates relative to water-dissolved approaches. Thus, embodiments of the disclosed subject matter improve carbon mineralization in basalt and substantially advance the scalability of WAG injection technology.

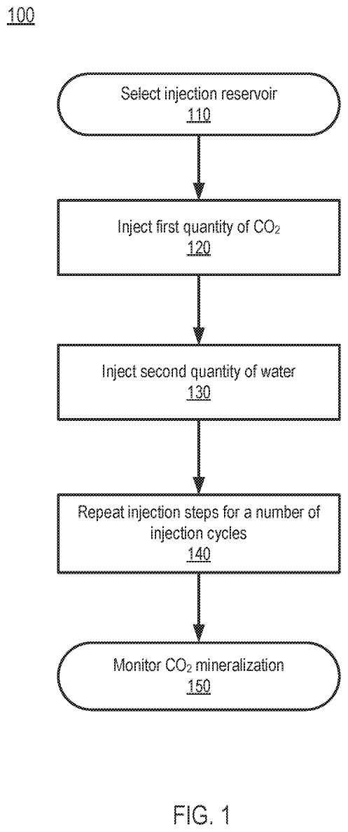

As shown in FIG. 1, a method of trapping and mineralizing CO₂ in a rock reservoir is generally designated by the numeral 100. At 110, the method 100 includes selecting an injection reservoir. In some embodiments, the injection reservoir is a rock reservoir, such as a mafic or ultramafic silicate rock. In some embodiments, the mafic silicate rock reservoir is basaltic, i.e., includes a concentration of basalt available for contacting with a fluid injected at the reservoir. At 120, the method 100 includes injecting a first quantity of CO₂ into the rock reservoir at a first rate and for a first duration. In some embodiments, the CO₂ is free-phase CO₂. In some embodiments, the free-phase CO₂ is in supercritical form. The supercritical CO₂ can be obtained by any suitable process, e.g., manufactured remotely and transported to the injection reservoir, manufactured proximate the injection reservoir, etc., or combinations thereof. In some embodiments, the CO₂ is pure-phase, supercritical CO₂. At 130, the method includes injecting a second quantity of water into the rock reservoir at a second rate and for a second duration. In some embodiments, the water is freshwater. In some embodiments, the water is seawater or brine. In some embodiments, the water is saturated with dissolved CO₂. In some embodiments, the water is sourced from the rock reservoir, e.g., extracted from the rock reservoir, to aid in reservoir pressure management and/or to reduce water requirements during injection.

At 140, the method includes repeating at least one of the above injection steps in an alternating fashion for a plurality of injection cycles. In some embodiments, each injection cycle includes a CO₂ injection sub-cycle of the first quantity of CO₂, e.g., consistent with step 120 described above, and a water injection sub-cycle of the second quantity of water, e.g., consistent with step 130 described above. In some embodiments, the CO₂ injection sub-cycle occurs before the water injection sub-cycle. In some embodiments, the water injection sub-cycle occurs before the CO₂ injection sub-cycle. Thus, the disclosed subject matter is not limited to any particular order of injection sub-cycles, provided that the CO₂ injection sub-cycle and the water injection sub-cycle are performed in an alternating fashion. In some embodiments, each injection cycle includes either a CO₂ injection of the first quantity of CO₂, e.g., consistent with step 120 described above, or a water injection of the second quantity of water, e.g., consistent with step 130 described above. In some embodiments, injection parameters such as the first quantity, the second quantity, the first rate, the second rate, the first duration, the second duration, and the total number of the plurality of injection cycles are selected to improve the mineralization efficiency at the rock reservoir. In some embodiments, the injection parameters are selected to improve the CO₂ trapped by dissolution in the rock reservoir. In some embodiments, the injection parameters are selected to reduce the amount of energy consumed throughout the injection process. In some embodiments, the injection parameters are selected to reduce the amount of water consumed within the rock reservoir. In some embodiments, the injected CO₂ is trapped in aqueous phase and/or is mineralized in the rock reservoir.

In some embodiments, the total number of the plurality of injection cycles is in the range of about 2 to about 400. In some embodiments, the total number of the plurality of injection cycles is in the range of about 2 to about 45. In some embodiments, the total number of the plurality of injection cycles is about 2. In some embodiments, the total number of the plurality of injection cycles is about 3. In some embodiments, the total number of the plurality of injection cycles is greater than about 45. In some embodiments, the total number of the plurality of injection cycles is in the range of about 20 to about 45. In some embodiments, the total number of the plurality of injection cycles is in the range of about 23 to about 45. In some embodiments, the total number of the plurality of injection cycles is in the range of about 37 to about 45. In some embodiments, the total number of the plurality of injection cycles is about 23.

In some embodiments, the first duration is in the range of about 1 day to about 416 days, and the second duration is in the range of about 1 day to about 1,900 days. In some embodiments, the first duration is in the range of about 5 days to about 416 days, and the second duration is in the range of about 12 days to about 1,900 days. In some embodiments, the first duration is in the range of about 13 days to about 278 days, and the second duration is in the range of about 66 days to about 1,900 days. In some embodiments, the first duration is in the range of about 29 days to about 278 days, and the second duration is in the range of about 180 days to about 1,900 days. In some embodiments, the first duration is about 30 days, and the second duration is about 200 days.

In some embodiments, the first rate is in the range of about 0.1% to about 2% of a first total quantity of free-phase CO₂ injected over the plurality of injection cycles in tons per day, and the second rate is in the range of about 0.8% to about 2.5% of a second total quantity of water injected over the plurality of injection cycles in tons per day. In some embodiments, the first rate is in the range of about 0.1% to about 0.6% of the first total quantity, and the second rate is in the range of about 1.2% to about 2.5%. In some embodiments, the first rate is in the range of about 0.001% to about 80% of the first total quantity, and the second rate is in the range of ab out 0.01% to about 80% of the second total quantity. In some embodiments, the first rate is in the range of about 0.001% to about 80% of the first total quantity. In some embodiments, the first rate is in the range of about 0.001% to about 50% of the first total quantity. In some embodiments, the first rate is in the range of about 0.001% to about 33% of the first total quantity. In some embodiments, the first total quantity of free-phase CO₂ injected over the plurality of injection cycles is about 1 Mt. In some embodiments, the first total quantity is about 2 Mt. In some embodiments, the first total quantity is in the range of about 100 tons to about 1 Mt. In some embodiments, the first total quantity is in the range of about 200 tons to about 2 Mt. In some embodiments, the first total quantity is in the range of about 100 tons to about 3 Mt.

In some embodiments, the first rate is in the range of about 10 tons per day to about 5,879 tons per day, and the second rate is in the range of about 1,500 tons per day to about 25,000 tons per day. In some embodiments, the first rate is in the range of about 1,500 tons per day to about 20,548 tons per day, and the second rate is in the range of about 12,500 tons per day to about 25,000 tons per day. In some embodiments, the first rate is in the range of about 1,015 tons per day to about 20,548 tons per day, and the second rate is in the range of about 4,284 tons per day to about 25,000 tons per day. In some embodiments, the first rate is in the range of about 1,500 tons per day to about 5,879 tons per day, and the second rate is in the range of about 12,500 tons per day to about 25,000 tons per day. In some embodiments, the first rate is in the range of about 1,500 tons per day to about 2,833 tons per day, and the second rate is in the range of about 12,500 tons per day to about 25,000 tons per day. In some embodiments, the first rate is about 2,833 tons per day, and the second rate is about 12,500 tons per day.

In some embodiments, the first rate is based, at least in part, on the first total quantity of free-phase CO₂ injected over the plurality of injection cycles in tons per day. For example, in one embodiment, the first total quantity is about 1,000 tons and the first rate is in the range of about 0.001% to about 80% of the first total quantity in tons per day, i.e., about 0.01 tons per day to about 800 tons per day. In another example embodiment, the first total quantity is about 5 Mt and the first rate is in the range of about 5,000 tons per day to about 4 Mt per day.

In some embodiments, the ratio of the second quantity to the first quantity is in the range of about 0.5 to about 242. In some embodiments, the ratio of the second quantity to the first quantity is less than 30. In some embodiments, the ratio of the second quantity to the first quantity is in the range of about 13 to about 242. In some embodiments, the ratio of the second quantity to the first quantity is in the range of about 27 to about 242. In some embodiments, the ratio of the second quantity to the first quantity is about 27.1. In some embodiments, the ratio of the second quantity to the first quantity is in the range of about 0.1 to about 35.

In some embodiments, the ratio of the second rate to the first rate is in the range of about 0.6 to about 16.7. In some embodiments, the ratio of the second rate to the first rate is in the range of about 2 to about 17. In some embodiments, the ratio of the second rate to the first rate is in the range of about 4 to about 17. In some embodiments, the ratio of the second rate to the first rate is about 4.4. In some embodiments, the ratio of the second rate to the first rate is in the range of about 0.1 to about 17.

In some embodiments, the ratio of the second duration to the first duration is in the range of about 0.3 to about 15.2. In some embodiments, the ratio of the second duration to the first duration is in the range of about 5 to about 16. In some embodiments, the ratio of the second duration to the first duration is in the range of about 2 to about 10. In some embodiments, the ratio of the second duration to the first duration is about 6.7. In some embodiments, the ratio of the second duration to the first duration is in the range of about 0.1 to about 16.

In some embodiments, at 150, the method 100 includes monitoring the mineralization of the injected CO₂ at the silicate site for a predetermined time. In some embodiments, the predetermined time is in the range of about 0 years to about 40 years. In some embodiments, the predetermined time is about 5 years. In some embodiments, the predetermined time is about 40 years. In some embodiments, the predetermined time is greater than 40 years.

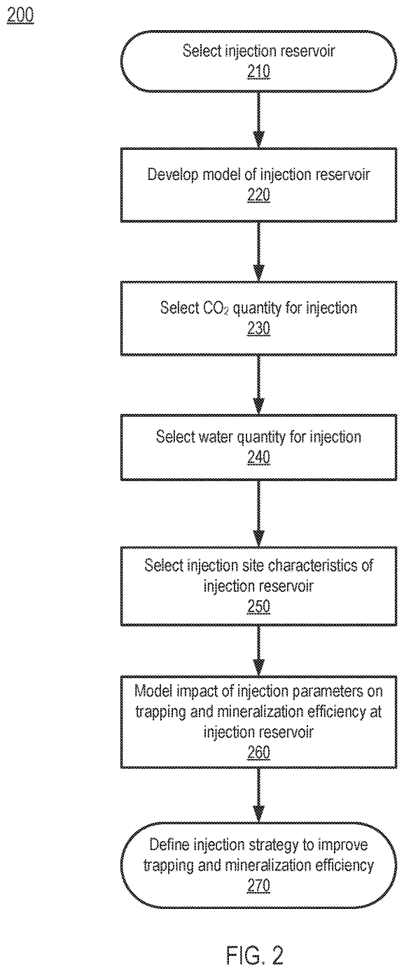

As shown in FIG. 2, a method of designing a strategy for injecting CO₂ and water in an alternating fashion for trapping and mineralizing the CO₂ in a rock reservoir is generally designated by the numeral 200. At 210, the method 200 includes selecting an injection reservoir. As discussed above, in some embodiments, the injection reservoir is a rock reservoir, such as a mafic or ultramafic silicate rock reservoir. In some embodiments, the mafic silicate rock reservoir is basaltic. At 220, the method 200 includes developing a model of the rock reservoir based on geologic and geophysical data at or near the rock reservoir. In some embodiments, the model of the silicate rock reservoir is a geological Earth model derived from field data obtained at or near an injection site of the rock reservoir. As used herein, the term “injection site” refers to a location of the rock reservoir where the CO₂ and/or the water is injected into the rock reservoir. In some embodiments, the CO₂ and the water are injected via the same injection site. In some embodiments, the CO₂ is injected via a first injection site, and the water is injected via a second injection site. In some embodiments, each injection cycle of the CO₂ occurs via a different injection site such that the rock reservoir includes a plurality of CO₂ injection sites. In some embodiments, each injection cycle of the water occurs via a different injection site such that the rock reservoir includes a plurality of water injection sites. Thus, the disclosed subject matter is not limited to any particular amount and arrangement of injection sites, provided that the CO₂ and the water are injected into the rock reservoir in an alternating fashion.

At 230, the method 200 includes selecting a quantity of CO₂ to be injected. In some embodiments, the quantity of CO₂ to be injected is about 1 million metric tons. In some embodiments, the CO₂ is free-phase CO₂. In some embodiments, the free-phase CO₂ is in supercritical form. In some embodiments, the CO₂ is pure-phase, supercritical CO₂. At 240, the method 200 includes selecting a quantity of water to be injected. In some embodiments, the quantity of water to be injected is at least partly based on the selected quantity of CO₂ to be injected. In some embodiments, the water is freshwater. In some embodiments, the water is seawater or brine. In some embodiments, the water is saturated with dissolved CO₂. In some embodiments, the water is sourced from the rock reservoir, e.g., extracted from the rock reservoir, to aid in reservoir pressure management and/or to reduce water requirements during injection.

At 250, the method 200 includes selecting characteristics associated with an injection site of the rock reservoir. In some embodiments, the injection site characteristics include injection depth, injection site porosity, injection site permeability, temperature, pressure, rock reservoir composition, rock reservoir geological age, and water depth, as shown and discussed in more detail below.

At 260, the method 200 includes modeling the impact on trapping and mineralization efficiency at the rock reservoir of a plurality of injection parameters. In some embodiments, modeling the impact on trapping and mineralization efficiency of the injection parameters accounts for the injection site characteristics of the rock reservoir, as discussed in more detail below. In some embodiments, the plurality of injection parameters include a plurality of injection cycles with each injection cycle including a first injection of CO₂ and a second injection of water, a ratio of the quantity of injected water to the quantity of injected CO₂, a ratio of the rate of water injection to the rate of CO₂ injection, and a ratio of the water injection cycle duration to the CO₂ injection cycle duration. In some embodiments, the plurality of injection parameters include the injection parameters and the respective ratios, ranges, and values discussed above regarding method 100.

In some embodiments, the total number of the plurality of injection cycles is in the range of about 2 to about 400. In some embodiments, the total number of the plurality of injection cycles is in the range of about 2 to about 45. In some embodiments, the total number of the plurality of injection cycles is about 2. In some embodiments, the total number of the plurality of injection cycles is about 3. In some embodiments, the total number of the plurality of injection cycles is greater than about 45. In some embodiments, the total number of the plurality of injection cycles is in the range of about 20 to about 45. In some embodiments, the total number of the plurality of injection cycles is in the range of about 23 to about 45. In some embodiments, the total number of the plurality of injection cycles is in the range of about 37 to about 45. In some embodiments, the total number of the plurality of injection cycles is about 23.

In some embodiments, the ratio of the quantity of injected water to the quantity of injected CO₂ is in the range of about 0.5 to about 242. In some embodiments, the ratio of the quantity of injected water to the quantity of injected CO₂ is less than 30. In some embodiments, the ratio of the quantity of injected water to the quantity of injected CO₂ is in the range of about 13 to about 242. In some embodiments, the ratio of the quantity of injected water to the quantity of injected CO₂ is in the range of about 27 to about 242. In some embodiments, the ratio of the quantity of injected water to the quantity of injected CO₂ is about 27.1.

In some embodiments, the ratio of the rate of water injection to the rate of CO₂ injection is in the range of about 0.60 to about 16.7. In some embodiments, the ratio of the rate of water injection to the rate of CO₂ injection is in the range of about 2 to about 17. In some embodiments, the ratio of the rate of water injection to the rate of CO₂ injection is in the range of about 4 to about 17. In some embodiments, the ratio of the rate of water injection to the rate of CO₂ injection is about 4.4.

In some embodiments, the ratio of the water injection cycle duration to the CO₂ injection cycle duration is in the range of about 0.3 to about 15.2. In some embodiments, the ratio of the water injection cycle duration to the CO₂ injection cycle duration is in the range of about 5 to about 16. In some embodiments, the ratio of the water injection cycle duration to the CO₂ injection cycle duration is in the range of about 2 to about 10. In some embodiments, the ratio of the water injection cycle duration to the CO₂ injection cycle duration is about 6.7.

In some embodiments, the injection parameters further include a first rate of CO₂ injection per injection cycle, and a second rate of water injection per injection cycle. In some embodiments, the first rate is in the range of about 0.1% to about 2% of a first total quantity of free-phase CO₂ injected over the plurality of injection cycles in tons per day, and the second rate is in the range of about 0.8% to about 2.5% of a second total quantity of water injected over the plurality of injection cycles in tons per day. In some embodiments, the first rate is in the range of about 0.1% to about 0.6% of the first total quantity, and the second rate is in the range of about 1.2% to about 2.5%. In some embodiments, the first rate is in the range of about 0.001% to about 80% of the first total quantity, and the second rate is in the range of ab out 0.01% to about 80% of the second total quantity. In some embodiments, the first rate is in the range of about 0.001% to about 80% of the first total quantity. In some embodiments, the first rate is in the range of about 0.001% to about 50% of the first total quantity. In some embodiments, the first rate is in the range of about 0.001% to about 33% of the first total quantity. In some embodiments, the first total quantity of free-phase CO₂ injected over the plurality of injection cycles is about 1 Mt. In some embodiments, the first total quantity is about 2 Mt. In some embodiments, the first total quantity is in the range of about 100 tons to about 1 Mt. In some embodiments, the first total quantity is in the range of about 200 tons to about 2 Mt. In some embodiments, the first total quantity is in the range of about 100 tons to about 3 Mt.

In some embodiments, the first rate is in the range of about 10 tons per day to about 5,879 tons per day, and the second rate is in the range of about 1,500 tons per day to about 25,000 tons per day. In some embodiments, the first rate is in the range of about 1,500 tons per day to about 20,548 tons per day, and the second rate is in the range of about 12,500 tons per day to about 25,000 tons per day. In some embodiments, the first rate is in the range of about 1,015 tons per day to about 20,548 tons per day, and the second rate is in the range of about 4,284 tons per day to about 25,000 tons per day. In some embodiments, the first rate is in the range of about 1,500 tons per day to about 5,879 tons per day, and the second rate is in the range of about 12,500 tons per day to about 25,000 tons per day. In some embodiments, the first rate is in the range of about 1,500 tons per day to about 2,833 tons per day, and the second rate is in the range of about 12,500 tons per day to about 25,000 tons per day. In some embodiments, the first rate is about 2,833 tons per day, and the second rate is about 12,500 tons per day.

In some embodiments, the first rate is based, at least in part, on the first total quantity of free-phase CO₂ injected over the plurality of injection cycles in tons per day. For example, in one embodiment, the first total quantity is about 1,000 tons and the first rate is in the range of about 0.001% to about 80% of the first total quantity in tons per day, i.e., about 0.01 tons per day to about 800 tons per day. In another example embodiment, the first total quantity is about 50 Mt and the first rate is in the range of about 500 tons per day to about 40 Mt per day.

In some embodiments, the injection parameters further include a first duration of CO₂ injection per injection cycle, and a second duration of water injection per injection cycle. In some embodiments, the first duration is in the range of about 1 day to about 416 days, and the second duration is in the range of about 1 day to about 1,900 days. In some embodiments, the first duration is in the range of about 5 days to about 416 days, and the second duration is in the range of about 12 days to about 1,900 days. In some embodiments, the first duration is in the range of about 13 days to about 278 days, and the second duration is in the range of about 66 days to about 1,900 days. In some embodiments, the first duration is in the range of about 29 days to about 278 days, and the second duration is in the range of about 180 days to about 1,900 days. In some embodiments, the first duration is about 30 days, and the second duration is about 200 days.

At 270, the method 200 includes defining the injection strategy by defining the plurality of injection parameters to improve the trapping and mineralization efficiency within the rock reservoir. In some embodiments, the defining step 270 further includes defining the plurality of injection parameters to improve solubility trapping. In some embodiments, the defining step 270 further includes defining the plurality of injection parameters to reduce energy consumption for the injection strategy. In some embodiments, the defining step 270 further includes defining the plurality of injection parameters to reduce water consumption for the injection strategy. Further details of how the injection strategy is defined are discussed below with reference to example embodiments.

### Examples

In some embodiments, simulator Earth models were designed across a cylindrical coordinate system. Geochemistry was modeled using the ECKE-Chem reactive transport module and the LLNL V8 R6 thermodynamic database. Different WAG scenarios under a range of input parameters were simulated for injection at the Cascadia, Louisville, and Wallula locations. A total mass of 1 million metric tons (“Mt”) of injected carbon dioxide was simulated in the reservoirs at the Cascadia and Louisville sites and monitored for 40 years. At these sites, the basaltic reservoir was initially saturated with seawater of the same composition to that observed for basaltic crustal fluid elsewhere in the region. Table 1 below shows a summary of the injection site characteristics associated with these sites.

TABLE 1
Summary of geophysical parameters at example sites.

| | Cascadia | Louisville | Wallula |
|---|---|---|---|
| Water depth (m) | 2700 | 1700 | — |
| Injection depth (meters | 440 | 456 | 830 |
| below seafloor/surface) | | | |
| Temperature (°C) | 62 | 37 | 35 |
| Pressure (MPa) | 34 | 28 | 79 |
| Maximum crust age (Ma) | <3.6 | <70.4 | <15.6 |
| Injection zone porosity (%) | 15 | 22 | 21.8 |
| Injection zone horizontal | 4.8 × 10⁻¹³ | 8.2 × 10⁻¹³ | 8 × 10⁻¹⁴ |
| permeability (m²) | | | |

In some embodiments, three different injection scenarios were simulated: 1) free-phase CO₂ only (also referred to herein as “scCO₂-only”); 2) CO₂ fully dissolved in seawater; and 3) alternating injections of CO₂ and seawater (“WAG”). In these simulations, seawater is assumed to contain 3.5% weight percent salt. WAG scenarios were designed to improve mineralization. Therefore, the relative performance of individual simulation scenarios is assessed based on mineralization efficiency, defined as:

$$Mineralization {Efficiency}_{t} ( \% ) = [ \frac{Mass of Injected {CO}_{2} - Mass of {CO}_{2 ( aq )} - Mass of {CO}_{2 ( g )}}{Mass of Injected {CO}_{2}} ] \times 100 \qquad ( 1 )$$

where mass of injected CO₂, aqueous (CO_{2(aq)} and gaseous (CO_{2(g)}, in metric tons, is specified at time t, thus, mineralization efficiency indicates the percentage of injected CO₂ mineralized at a given time.

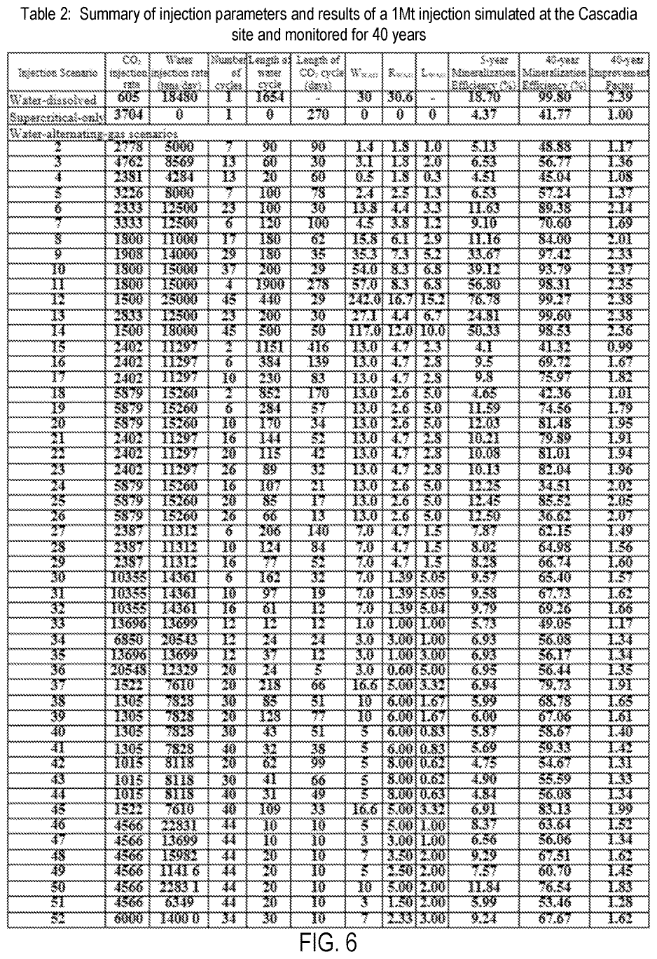

In some embodiments, injection parameters for the WAG injection scenarios are defined using four main variables, “W_{WAG}”, “R_{WAG}”, “L_{WAG}”, and “N”. W_{WAG} refers to the ratio of the total mass of injected water and the total mass of injected CO₂ and thus approximates water consumption for a given scenario. The variable R_{WAG} is the ratio of water injection rate to CO₂ injection rate, and L_{WAG} is the ratio of the water injection cycle length (i.e., cycle duration) to the CO₂ injection cycle length. N corresponds to the total number of WAG cycles in each scenario. To assess the relative control of these WAG injection parameters on mineralization at the Cascadia site, simulations were designed to produce a range of values for each variable, and results were recorded after each simulation, as shown in Table 2 in FIG. 6. Results were interpreted to determine which values of the variables W_{WAG}, R_{WAG}, L_{WAG}, and N produce the highest mineralization efficiencies, hence improving the injection parameters for mineralization. In some embodiments, given practical considerations regarding water use, simulated scenarios have a W_{WAG} of <30.

In some embodiments, to constrain the reservoir characteristics that have the largest impacts on mineralization, a first-order sensitivity analysis was performed using data from the Cascadia site. A subset of WAG scenarios with ranging values for W_{WAG}, R_{WAG}, L_{WAG}, and N was simulated repeatedly using stepwise changes in permeability, porosity, and injected water composition (seawater versus freshwater) to higher and lower values is shown in Table 3 below. The same subset of significantly improved WAG scenarios, along with a water-dissolved injection and scCO₂-only injection, were simulated at the Louisville Seamount and Wallula sites. Note that some injection scenarios resulted in overpressures, and when necessary, the maximum allowable well-top pressure was adjusted slightly to allow for the injection. At Wallula, these slight changes to the maximum allowable well-top pressure did not allow for the model to converge; thus, the injection size was reduced. The four parameters (W_{WAG}, R_{WAG}, L_{WAG}, and N) were consistent for a given scenario across all three geological models, despite the smaller injection size at Wallula.

TABLE 3
Values of parameters adjusted for the sensitivity analysis at the
Cascadia site. Permeability was calculated from hydraulic
conductivity (in m/s) using the density and dynamic viscosity
of water at 60 °C representative of the injection zone temperature.

| | | | |
|---|---|---|---|
| | | Massive | Vesicular |
| Parameter | Breccia | Flow | Lava |

Porosity (%)

| | | | |
|---|---|---|---|
| low | 10% | 1.0% | 2.5% |
| medium (actual) | 15% | 2.5% | 7.5% |
| high | 25% | 12.5% | 17.5% |

Horizontal permeability (m²)

| | | | |
|---|---|---|---|
| low | 4.83 × 10⁻¹⁴ | 4.83 × 10⁻¹⁹ | 4.83 × 10⁻¹⁵ |
| medium (actual) | 4.83 × 10⁻¹³ | 4.83 × 10⁻¹⁹ | 4.83 × 10⁻¹⁴ |
| high | 4.83 × 10⁻¹² | 4.83 × 10⁻¹⁷ | 4.83 × 10⁻¹³ |

Vertical permeability (m²)

| | | | |
|---|---|---|---|
| low | 4.83 × 10⁻¹⁵ | 4.83 × 10⁻²¹ | 4.83 × 10⁻¹⁶ |
| medium (actual) | 4.83 × 10⁻¹⁴ | 4.83 × 10⁻²¹ | 4.83 × 10⁻¹⁵ |
| high | 4.83 × 10⁻¹³ | 4.83 × 10⁻¹⁹ | 4.83 × 10⁻¹⁴ |

Table 2 in FIG. 6 shows results of the 1 Mt CO₂ injection over 40 years at the Cascadia site. With one exception, the 40-year mineralization efficiency for Cascadia is lowest for the scCO₂-only scenario, at 41.8%. The WAG scenarios produce mineralization efficiency results ranging from 41.3% to 99.6%, and the seawater-dissolved scenario results in the highest mineralization efficiency of 99.8% after 40 years. The highest mineralization efficiencies in WAG scenarios correspond to those with high W_{WAG}, and for scenarios with low water use, mineralization efficiency generally correlates with L_{WAG}. To assess the improvement in mineralization efficiency using WAG injection relative to the scCO₂-only scenario over a given time period, the performance of a WAG injection scenario was defined using a dimensionless ratio, IF, as follows:

$$Improvement Factor ( IF ) ( \% ) = [ \frac{Mineralization Efficiency for WAG injection i}{Mineralization Efficiency for {scCO}_{2} - only injection} ] \times 100 \qquad ( 2 )$$

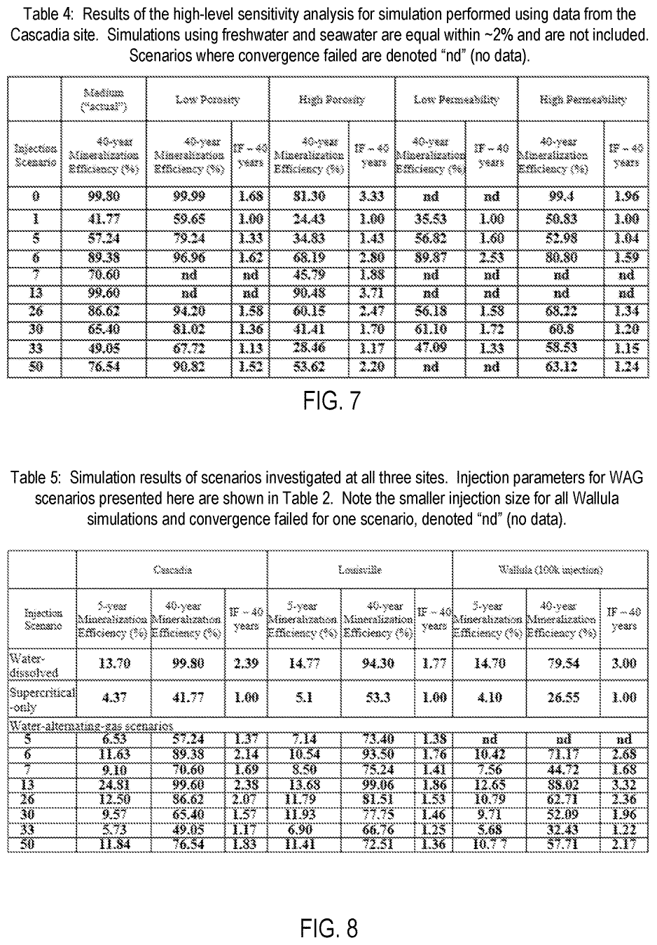

Values of IF>1 indicate improved mineralization efficiency for WAG scenario I, relative to a scCO₂-only scenario under the same conditions. For example, a WAG scenario with IF=2 indicates twice as much injected CO₂ will be mineralized at a given time compared to a scCO₂-only (non-WAG) injection scenario. While the maximum possible values of IF differ between sites due to different initial scCO₂-only mineralization efficiency, the IF value serves as a first-order approximation of performance relative this initial condition. To investigate the effects of injection zone permeability, porosity, and injected water composition (seawater versus freshwater) on mineralization, several scenarios at the Cascadia site were simulated with parameters adjusted from those shown in Table 3. Importantly, using seawater rather than freshwater produces nearly identical mineralization efficiencies for all WAG scenarios. Table 4 in FIG. 7 indicates that low-porosity scenarios produce the highest mineralization efficiencies and that IF increases the most for high-porosity scenarios.

At the Cascadia site, WAG injection scenarios improve mineralization efficiency after 40 years by an average of IF=1.68±0.38 (n=51), and the water-dissolved injection scenario shows the highest IF=2.39 (Table 2 in FIG. 6). At Louisville and Wallula sites, however, optimized WAG injection scenarios produce higher IF values than the water-dissolved approach, as shown in Table 5 in FIG. 8. At the Louisville site, 40-year mineralization efficiencies range from 53.3% for the scCO₂-only scenario to 99.0% for a WAG scenario, and this site shows overall higher mineralization efficiencies than observed at Cascadia. Unlike Cascadia, where the best results were produced by a water-dissolved injection, improved WAG injections at both Louisville and Wallula produce the highest 40-year mineralization efficiencies (99.0% and 88.0%, respectively). WAG injections improve mineralization most at the Wallula site, where an improved WAG scenario more than triples 40-year mineralization efficiency relative to scCO₂-only (IF=3.32), and this WAG scenario also results in ~10% more mineralization than the water-dissolved approach (Table 5 in FIG. 8). Mineralization efficiencies at Wallula are overall much lower than those for the offshore sites, the lowest being 26.6% after 40 years for the scCO₂-only injection. ScCO₂-only injection scenarios result in the largest variations in mineralization efficiency between the three sites.

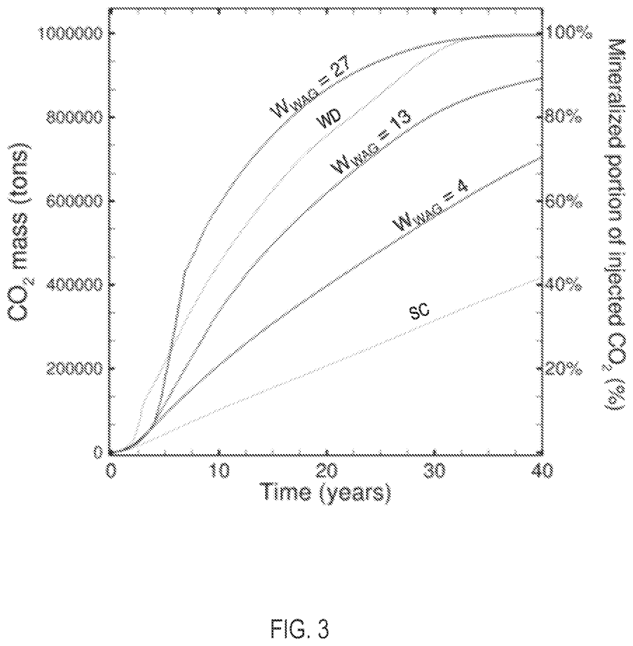

FIG. 3 shows a chart of the mass of mineralized CO₂ versus time for select simulations of a 1 Mt injection of CO₂ into the Cascadia basin. The secondary y-axis shows the percentage of injected CO₂ mineralized throughout the length of the simulation. WAG injections with varying W_{WAG} values result in significantly more mineralization than a supercritical-only injection at this site (labeled SC). For the seawater-dissolved injection here (labeled WD), W_{WAG}=30. The simulation where W_{WAG}=27 resulted in the fastest mineralization, as indicated by the steep slope~4.5 years after the start of the injection. As shown in Table 2 in FIG. 6 and in FIG. 3, an improved WAG injection using a water-to-CO₂ ratio of 4 nearly doubles the amount of mineralized CO₂ after 5 years (IF=2) and increases the mineralization efficiency after 40 years from 41% to 71%. In some embodiments, injection scenarios where W_{WAG}>30 result in the fastest mineralization, as shown in Table 2 in FIG. 6.

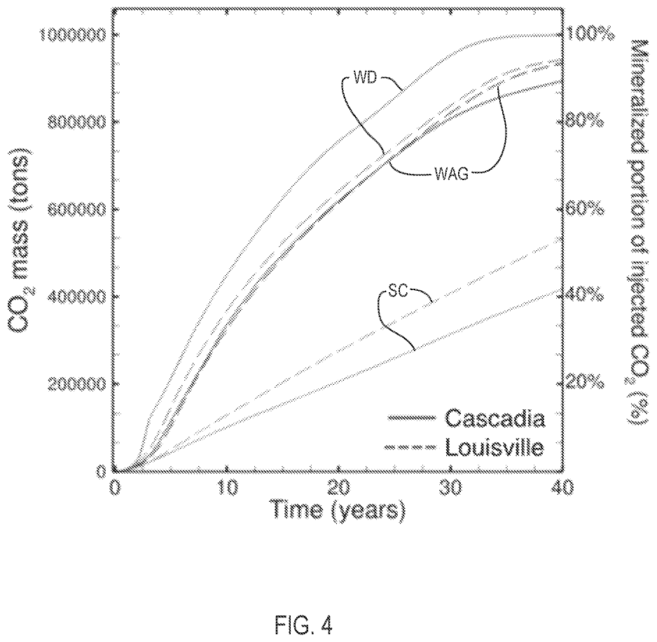

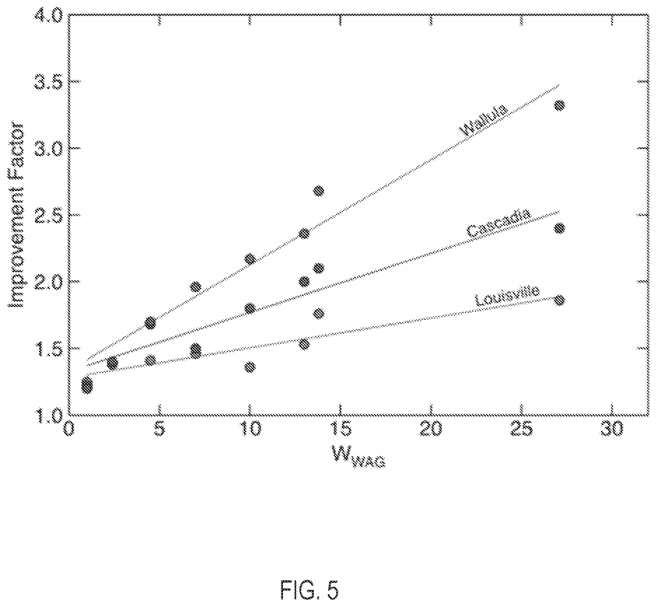

In some embodiments, to assess site-specific factors that may impact mineralization efficiency during a WAG injection, a subset of scenarios with ranging values of W_{WAG} were simulated at offshore sites Louisville Seamount and the Cascadia basin. Results are summarized in Table 5 in FIG. 8. WAG injections reduced site-specific variations in mineralization efficiency, as shown in FIG. 4. FIG. 4 is a chart showing the mass of mineralized CO₂ over time for three injection strategies simulating the 1 Mt injection of CO₂ into both Cascadia (solid lines) and Louisville (dashed lines) sites. The secondary y-axis shows the percentage of injected CO₂ mineralized throughout the length of the simulation. The difference between the sites is more pronounced for the scCO₂-only injections (labeled SC) and water-dissolved injections (labeled WD) than for the WAG injections (labeled WAG). Generally, mineralization efficiency was highest at Louisville, an unexpected result given that the Cascadia site has a higher temperature and contains younger basalts (Table 1). Although the reaction rates were assumed to be the same at both offshore sites, the target injection zone at the Louisville Seamount contains a larger proportion of olivine, further underscoring the first-order control of mineralogy in mineralization efficiency. This, as well as the higher porosity, contributed to the result that the scCO₂-only injection was most effective at the Louisville site, leading to lower IF values for WAG scenarios simulated here, as shown in FIG. 5. FIG. 5 is a chart showing the Improvement Factor for the subset of WAG scenarios simulated at all three sites versus W_{WAG}. A strong correlation exists for all three sites, with WAG at Wallula showing the strongest improvement (R²=0.95), followed by Cascadia (R²=0.86), then Louisville (R²=0.81). Given the low 40-year mineralization efficiency for the 100,000 t scCO₂-only injection at Wallula, subsequent WAG simulations at this site accordingly produced the highest IF values, as shown in FIG. 5. WAG injections at this site, and potentially in other continental flood basalt regions, dramatically improve mineralization. For example, an injection scenario with W_{WAG}=7 at Wallula doubles the amount of CO₂ mineralized after both 5 years and 40 years relative to the scCO₂-only scenario (Table 5 in FIG. 8). The performance of a WAG injection increases linearly with W_{WAG} for all three sites; however, the relationship is strongest for the Wallula site (FIG. 5; R²=0.95). Thus, in generally less favorable reservoirs (less reactive phases, lower temperature, lower permeability), WAG injection strategies significantly improve mineralization efficiency.

Accordingly, embodiments of the disclosed subject matter are directed to methods of carbon storage in basalt using WAG injection strategies that demonstrate the potential of large-scale mineral storage in both onshore and offshore rock reservoirs. The WAG methods disclosed herein drastically improve mineralization of CO₂ in basalts relative to free-phase-only injections and demonstrate that high water-to-gas ratios and short CO₂ cycles contribute to fast mineralization. Simulations at the Louisville site show the highest mineralization efficiency; however, the Wallula site shows the greatest improvement in mineralization with WAG strategies relative to free-phase-only, suggesting that for sites with characteristics that are less favorable for mineralization (e.g., low temperature, slow rates, low permeability) WAG injections significantly improve mineralization efficiency. Thus, implementing WAG strategies broadens the geographic range in which mineralization projects are feasible. Moreover, the disclosed subject matter demonstrates that WAG is a method of enhancing rapid geochemical trapping during free-phase CO₂ injections for geologic storage.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded. The term “and/or” means any one of the items, any combination of the items, or all of the items with which this term is associated. The phrase “one or more” is readily understood by one of skill in the art, particularly when read in context of its usage. Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of trapping and mineralizing CO₂ in a rock reservoir, comprising:
injecting a first quantity of free-phase CO₂ into the rock reservoir at a first rate and for a first duration;
injecting a second quantity of water into the rock reservoir at a second rate and for a second duration; and
repeating at least one of the above injection steps in an alternating fashion for a plurality of injection cycles.

2. The method of claim 1, wherein the CO₂ is trapped in aqueous phase and/or mineralized in the rock reservoir.

3. The method of claim 1, wherein the rock reservoir is basaltic, silicate, mafic, ultramafic, sedimentary, or combinations thereof.

4. The method of claim 1, wherein the free-phase CO₂ is supercritical CO₂.

5. The method of claim 1, wherein the water is freshwater, seawater, brine, or combinations thereof.

6. The method of claim 1, wherein the water is sourced from the rock reservoir.

7. The method of claim 1, wherein the total number of the plurality of injection cycles is in the range of about 2 to about 45.

8. The method of claim 1, wherein the first duration is in the range of about 1 day to about 416 days, and the second duration is in the range of about 1 day to about 1,900 days.

9. The method of claim 1, wherein the first rate is in the range of about 0.001% to about 80% of a first total quantity of free-phase CO₂ injected over the plurality of injection cycles in tons per day, and the second rate is in the range of about 0.001% to about 80% of a second total quantity of water injected over the plurality of injection cycles in tons per day.

10. The method of claim 1, wherein a ratio of the second quantity to the first quantity is less than 30.

11. The method of claim 1, wherein a ratio of the second rate to the first rate is in the range of about 0.60 to about 16.7.

12. The method of claim 1, wherein a ratio of the second duration to the first duration is in the range of about 0.3 to about 15.2.

13. A method of designing a strategy for injecting CO₂ and water in an alternating fashion for trapping and mineralizing the CO₂ in a rock reservoir, comprising:
developing a model of the rock reservoir based on geologic and geophysical data at or near the rock reservoir;
selecting a quantity of CO₂ to be injected;
selecting a quantity of water to be injected;
selecting characteristics associated with an injection site of the rock reservoir;
modeling the impact on trapping and mineralization efficiency at the rock reservoir of a plurality of injection parameters at least partly based on the selected injection site characteristics, the plurality of injection parameters comprising:
a plurality of injection cycles, each injection cycle including a first injection of CO₂ and a second injection of water;
a ratio of the quantity of injected water to the quantity of injected CO₂;
a ratio of the rate of water injection to the rate of CO₂ injection; and
a ratio of the water injection cycle duration to the CO₂ injection cycle duration; and
defining the injection strategy by defining the plurality of injection parameters to improve trapping and mineralization efficiency, reduce energy consumption, and reduce water consumption.

14. The method of claim 13, wherein a total number of the plurality of injection cycles is in the range of about 2 to about 400.

15. The method of claim 13, wherein the ratio of the quantity of injected water to the quantity of injected CO₂ is in the range of about 0.5 to about 242.

16. The method of claim 13, wherein the ratio of the rate of water injection to the rate of CO₂ injection and the ratio of the water injection cycle duration to the CO₂ injection cycle duration are each in the range of about 0.3 to about 16.7.

17. The method of claim 13, wherein the rock reservoir is basaltic, silicate, mafic, ultramafic, sedimentary, or combinations thereof.

18. The method of claim 13, wherein the CO₂ is free-phase CO₂, and the water is freshwater, seawater, brine, water sourced from the rock reservoir, or combinations thereof.

19. The method of claim 13, wherein the injection site characteristics comprise injection depth, injection site porosity, injection site permeability, temperature, pressure, rock reservoir composition, rock reservoir geological age, and water depth.

20. A method of trapping and mineralizing CO₂ in a rock reservoir, comprising:
injecting a first quantity of supercritical CO₂ into the rock reservoir at a first rate and for a first duration;
injecting a second quantity of water into the rock reservoir at a second rate and for a second duration, the water being freshwater, seawater, brine, water sourced from the rock reservoir, or combinations thereof; and
repeating at least one of the above injection steps in an alternating fashion for a plurality of injection cycles;
wherein the total number of the plurality of injection cycles is in the range of about 1 to about 400, a ratio of the second quantity to the first quantity is in the range of about 0.1 to about 35, a ratio of the second rate to the first rate is in the range of about 0.1 to about 17, and a ratio of the second duration to the first duration is in the range of about 0.1 to about 16.
